(19) United States
(12) Patent Application Publication
(10) Pub. No.: US 2008/0050463 A1
(43) Pub. Date: Feb. 28, 2008

(54) Stacked type tooling

(76) Inventor: Chen-Yang Lin, Jhubei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/508,254

(22) Filed: Aug. 23, 2006

(51) Int. Cl. B29C 45/00

(52) U.S. Cl. 425/338; 425/579; 425/182; 249/126; 249/110

(57) ABSTRACT

A stacked type tooling is formed by stacking a plurality of slices. Each slice has a plurality of patterned openings. When these slices are stacked together, The patterned openings form at least a cavity. Unnecessary volume of the tooling can be avoided to shrink the size of the tooling and let the tooling be lightweight. Moreover, the manufacturing cost and time of the tooling can be substantially reduced.

### BACKGROUND OF THE INVENTION

1. Field of the Invention

The present invention relates to a tooling structure and, more particularly, to a stacked type tooling that is lightweight and can be manufactured with a high efficiency.

2. Description of Related Art

With continual progress of science and technology, people have developed various articles for daily use and constantly weed through the old to bring forth the new, especially the consumer electronic products, whose components are generally manufactured by means of mechanical processing technique such as tooling. In order to carry out the processing procedure of components, it is necessary to first provide a tooling for casting prototypes and then accomplish mass production by means of mold filling.

A tooling is a tool for a special purpose that can provide injection of melted shaping liquid to form a predetermined shape and construct an article. Common shaping liquids are plastic liquids, metal liquids and so on. Hot shaping liquid is first injected into a tooling, and the tooling is then cooled to fix and shape the mold. Next, the mold is ejected using an ejection system. Because the shaping liquid injected into the tooling needs to be heated first, a cooling system is generally designed on a common tooling. Besides, because the mold has to be ejected after cooling, the tooling needs to has an ejection system. Added with the original cavity in the tooling, the manufacturing process of the tooling is very complicated. Moreover, with existent techniques, the manufacturing procedures of the above cavity, cooling system and ejection system are generally carried out by means of drilling in several times, hence consuming a large amount of time and money. Besides, because the conventional tooling has to undergo the drilling process, the material and volume of the tooling need to be taken into account for the bearable structural strength and the required reserved space in each drilling step. In other words, both the volume and material of the conventional tooling are factors to be taken into consideration so that the size and weight of the tooling cannot be shrunk or reduced.

Accordingly, the present invention aims to propose a stacked type tooling that can efficiently and substantially reduce the time and cost for manufacturing a tooling.

### SUMMARY OF THE INVENTION

An object of the present invention is to provide a staked type tooling, which is manufactured in a stacking manner to simultaneously finish the cavity, the cooling system and the ejection system, thereby substantially reduce the manufacturing cost and time of the tooling.

Another object of the present invention is to provide a staked type tooling, in which unnecessary volume of the tooling can be avoided to shrink the size of the tooling and let the tooling be lightweight.

According to the present invention, a stacked type tooling is formed by stacking a plurality of slices. Each slice has at least a patterned opening. When these slices are stacked together, the patterned openings form at least a chamber.

### BRIEF DESCRIPTION OF THE DRAWINGS

The various objects and advantages of the present invention will be more readily understood from the following detailed description when read in conjunction with the appended drawing, in which:

FIG. 1 is a perspective view of the present invention;

FIG. 2 is an exploded perspective cross-sectional view of the present invention; and

FIG. 3 is a perspective view of the present invention when stacked together.

### DETAILED DESCRIPTION OF THE PREFERRED EMBODIMENTS

In order to conquer the drawbacks of high cost and low efficiency in the prior art, the present invention proposes a stacked type tooling.

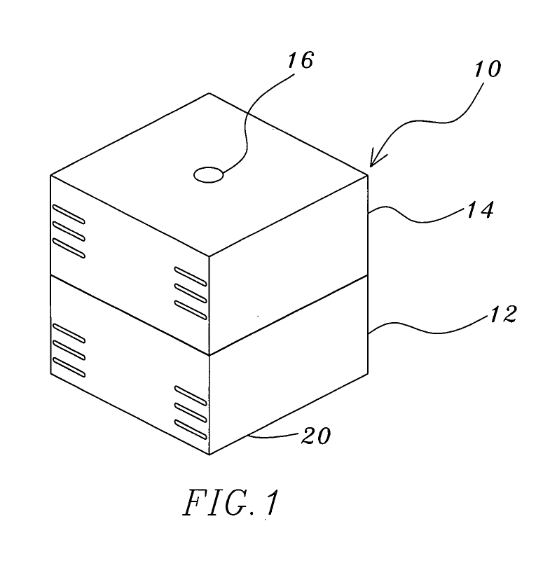

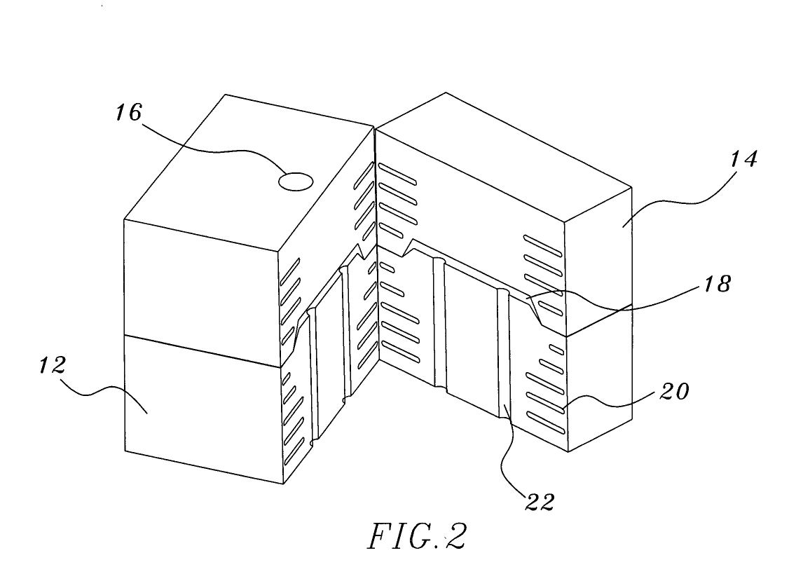

As shown in FIGS. 1 and 2, a stacked type tooling 10 comprises a male mold 12 and a female mold 14. A filling hole 16 is disposed on the male mold 12. A cavity 18 is formed between the male mold 12 and the female mold 14. The filling hole 16 can be connected with the cavity 18. The filling hole 16 is provided for a melted shaping liquid to fill and flow into the cavity 18. A cooling system and an ejection system are also provided in the tooling 10. In this embodiment, the cooling system is realized with a plurality of passages 20, and the ejection system is realized with four through holes 22 in the male mold 12. The cooling system can cool the filled shaping liquid to form a mold body, and the ejection system can eject the mold body.

Before manufacture, the stacked type tooling 10 of the present invention will first be simulated on computer. That is, based on the idea of the designer, the mold is first built on computer, and the tooling is then built on the mold. Next, the cooling system and the ejection system are added in the tooling. Subsequently, slicing simulation is performed to the built tooling to quickly manufacture the prototype in a stacking way. Computer software in common use include Autocad, Solid-work, and Pro-Engineer and so on. From computer simulation, the smallest area and thickness and the arranged position of each slice can be known, and the tooling can finally be manufactured in a stacking way.

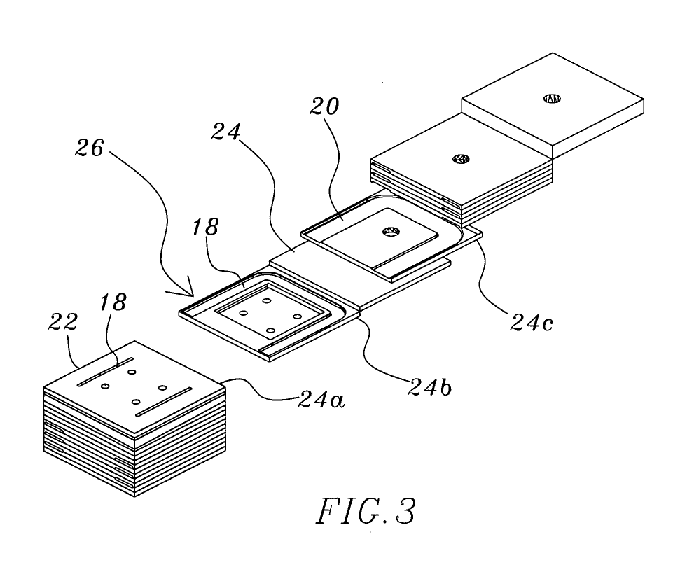

As shown in FIGS. 2 and 3, making use of the above computer simulation, a plurality of slices 24 can be stacked together to form the tooling 10. Data such as the size, area, thickness and position of each slice 24 can be got from the computer simulation. Besides, The slice 24 is made of metal or refractory material. The slices 24 are stacked together by means of laser spot welding, resistance welding, adhesion or supersonic bonding. The adhesion can be accomplished by using an adhesive or in an alloy form. In this embodiment, the slices 24 are stacked together by means of laser spot welding, in which a laser light is directly projected onto the surface of the slice 24 for precision welding. Because this kind of welding only produces a little heat, other parts won't be affected. The material of the slice 24 is metal.

In addition to the cavity, the tooling 10 also has a cooling system and an ejection system, both of which are realized with through holes or passages. When the tooling 10 is formed by stacking a plurality of slices 24 together, several patterned openings 26 is disposed on each slice 24. As shown in FIG. 3, a slice 24a has part of through holes 22 of the ejection system and the cavity 18, and a slice 24b has part of the cavity 18 with a larger region, and a slice 24c has part of the filling hole 16 and a passage 20 of the cooling system. Therefore, the patterned opening 26 on each slice 24 can be selected among the cavity 18, the filling hole 16 and part of the cooling system and the ejection system. The patterned opening 16 is formed by cutting using a knife or laser. The slices 24 are stacked together according to the data (arranged position, thickness and area) provided by the computer simulation. After stacking, a plurality of chambers is formed in the tooling 10. These chambers 18 include the cavity 18, the filling hole 16, the passages 20 of the cooling system, and the through holes 22 of the ejection system.

To sum up, the present invention is based on the computer simulation in advance to know data of each slice so as to save the expensive manufacturing cost of the tooling. Moreover, a prototype with an arbitrarily complex shape or subtle mechanisms can be manufactured. Restrictions of the cutting processing is totally got rid of, and the drawback of easy distortion of the handmade mold is conquered. Therefore, the cavity, the cooling system and the ejection system can be simultaneously finished when manufacturing the tooling, thereby substantially reducing the manufacturing cost and time of the tooling. Moreover, unnecessary volume of the tooling can be avoided to shrink the size of the tooling and let the tooling be lightweight.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A stacked type tooling formed by stacking a plurality of slices, each said slice having at least a patterned opening, said patterned openings forming at least a chamber when said slices are stacked together.

2. The stacked type tooling as claimed in claim 1, wherein said slice is made of metal or refractory material.

3. The stacked type tooling as claimed in claim 1, wherein said patterned opening is formed by cutting using a knife or laser.

4. The stacked type tooling as claimed in claim 1, wherein said slices are stacked together by means of laser spot welding, resistance welding or supersonic bonding.

5. The stacked type tooling as claimed in claim 1, wherein said chamber is a cavity, an ejection passage or a cooling passage.

6. The stacked type tooling as claimed in claim 1, wherein when there are a plurality of chambers, said chambers can be selected among cavities, ejection passages and cooling passages.

7. The stacked type tooling as claimed in claim 1, wherein said slices are stacked together by means of adhesion.

8. The stacked type tooling as claimed in claim 7, wherein the adhesion is accomplished by using an adhesive or in an alloy form.
